(19) United States
(12) Patent Application Publication
(10) Pub. No.: US 2023/0363586 A1
(43) Pub. Date: Nov. 16, 2023

(54) Insulated Water Bottle Assembly

(71) Applicant: Jestin Allen, Kingston, WA (US)

(72) Inventor: Jestin Allen, Kingston, WA (US)

(21) Appl. No.: 17/742,506

(22) Filed: May 12, 2022

(51) Int. Cl. A47J 41/00; A45F 3/18; B65D 43/02

(52) U.S. Cl. CPC A47J 41/0072; A45F 3/18; B65D 43/0229

(57) ABSTRACT

An insulated water bottle assembly for provision of cold, substantially sterile water includes a shell, which defines an interior space. The shell is formed to define a container, which comprises an inner wall, an outer wall, and an open top. The inner wall comprises copper and the outer wall comprises stainless steel. Water is positionable in the container, positioning a user to dispense the water from the open top. The inner wall, by comprising copper, inhibits growth of microbes and contributes copper ions to the water positioned in the container. An insulator is positioned in the interior space and limits heat transfer from the water in the container to the ambient environment, thereby keeping the water cold.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to water bottle assemblies and more particularly pertains to a new water bottle assembly for provision of cold, substantially sterile water. The present invention discloses a water bottle assembly comprising a double-walled container having an inner wall, which comprises copper, and an outer wall, which comprises stainless steel. An insulator is positioned between the inner and outer walls.

### (2) Description of Related Art Including Information Disclosed Under 37 CFR 1.97 and 1.98

The prior art relates to water bottle assemblies. Prior art water bottle assemblies may comprise beverage containers having copper rims and beverage containers that are double-walled. Related prior art comprises cookware having copper as a core, a plating, or as the sole material. What is lacking in the prior art is a water bottle assembly comprising a double-walled container having an inner wall, which comprises copper, and an outer wall, which comprises stainless steel. An insulator is positioned between the inner and outer walls to limit heat transfer from water in the container to the ambient environment.

### BRIEF SUMMARY OF THE INVENTION

An embodiment of the disclosure meets the needs presented above by generally comprising a shell, which defines an interior space. The shell is formed to define a container, which comprises an inner wall, an outer wall, and an open top. The inner wall comprises copper and the outer wall comprises stainless steel. The container is configured for positioning of water. A user thus is positioned to dispense the water from the open top. The inner wall, by comprising copper, is configured to inhibit growth of microbes and to contribute copper ions to the water positioned in the container. An insulator is positioned in the interior space and is configured to limit heat transfer from the water in the container to the ambient environment, thereby keeping the water cold.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of an insulated water bottle assembly according to an embodiment of the disclosure.

FIG. 2 is a side view of an embodiment of the disclosure.

FIG. 3 is a bottom view of an embodiment of the disclosure.

FIG. 4 is a cross-sectional view of an embodiment of the disclosure.

### DETAILED DESCRIPTION OF THE INVENTION

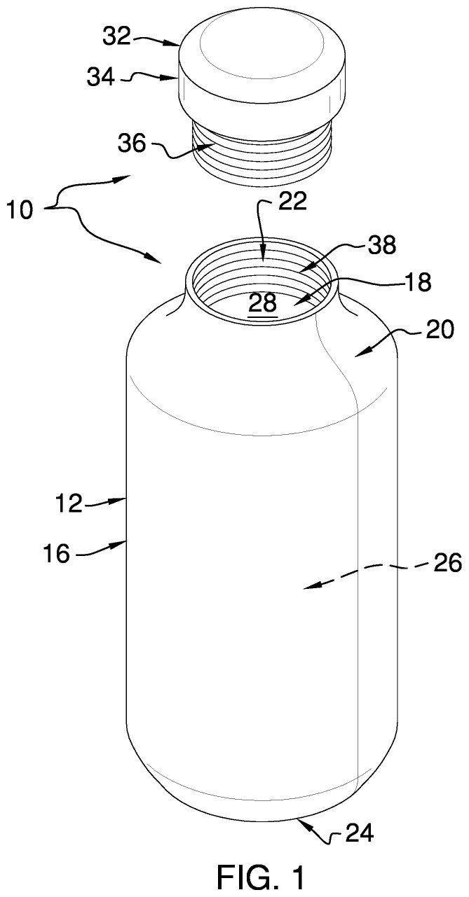

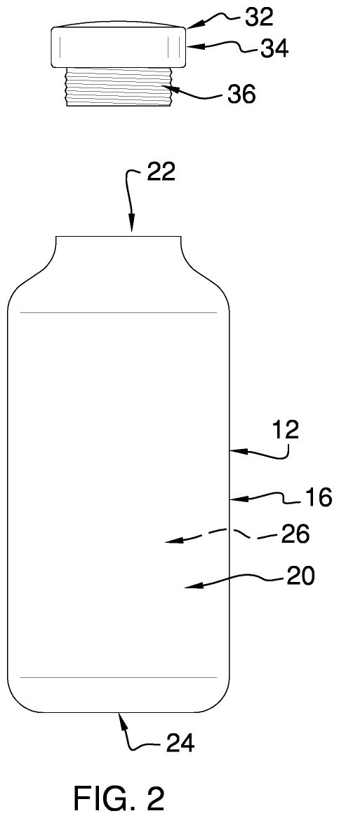

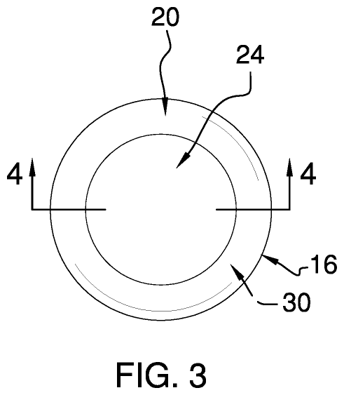

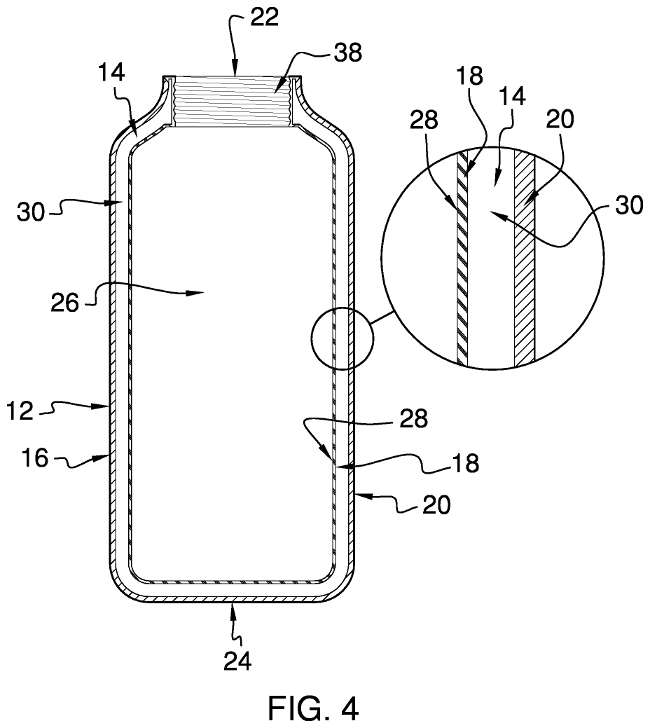

With reference now to the drawings, and in particular to FIGS. 1 through 4 thereof, a new water bottle assembly embodying the principles and concepts of an embodiment of the disclosure and generally designated by the reference numeral 10 will be described.

As best illustrated in FIGS. 1 through 4, the insulated water bottle assembly 10 generally comprises a shell 12, which defines an interior space 14. The shell 12 is formed to define a container 16, which comprises an inner wall 18, an outer wall 20, and an open top 22. The container 16 may be substantially cylindrical, as shown in FIG. 1, or alternatively shaped, such as cuboid, spherical, and the like. The container 16 is tapered adjacent to the open top 22 so that the open top 22 is circumferentially smaller than a bottom 24 of the container 16.

The inner wall 18 comprises copper and the outer wall 20 comprises stainless steel. The container 16 is configured for positioning of water 26 so that a user is positioned to dispense the water 26 from the open top 22. The inner wall 18 is configured to inhibit growth of microbes and to contribute copper ions to the water 26 positioned in the container 16. The inner wall 18 may comprise copper plated stainless steel so that copper is positioned on an inner surface 28 of the inner wall 18 and in contact with the water 26 in the container 16. The antimicrobial effects of copper are well established in the prior art.

An insulator 30 is positioned in the interior space 14 and is configured to limit heat transfer from the water 26 in the container 16 to the ambient environment, thereby keeping the water 26 cold. The insulator 30 comprises a gas, such as air, nitrogen, or a noble gas, or foamed elastomer.

The insulated water bottle assembly 10 also may comprise a lid 32, which is selectively engageable to the shell 12 to reversibly close the open top 22. The lid 32 may comprise a cap 34 having external threads 36 that are complementary to internal threads 38 positioned in the shell 12 adjacent to the open top 22. The cap 34 is selectively threadedly engageable to the shell 12 to reversibly close the open top 22. The lid 32 also may comprise other closing means, such as, but not limited to, internally threaded caps, corks, stoppers, and the like.

In use, water 26 for drinking is positioned in the container 16 and the cap 34 is threadedly engaged to the shell 12 to reversibly close the open top 22. The inner wall 18, by comprising copper, inhibits growth of microbes and contributes copper ions to the water 26 positioned in the container 16. Copper ions are believed to have health benefits, such as, but not limited to, production of energy, connective tissues, and neurotransmission. The insulator 30 positioned in the interior space 14 limits heat transfer from the water 26 in the container 16 to the ambient environment, thereby keeping the water 26 cold.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. An insulated water bottle assembly comprising:
a shell defining an interior space, the shell being formed to define a container comprising an inner wall, an outer wall, and an open top, the inner wall comprising copper, the outer wall comprising stainless steel, wherein the container is configured for positioning of water, such that a user is positioned for dispensing the water from the open top, wherein the inner wall is configured for inhibiting growth of microbes and for contributing copper ions to the water positioned in the container, the shell including a cylindrical threaded section extending vertically between a top edge of the outer wall and a top edge of the inner wall, a space between the outer wall and the inner wall being constant from the top edge of the wall downward within the shell; and
an insulator positioned in the interior space, wherein the insulator is configured for limiting heat transfer from the water in the container to the ambient environment.

2. The insulated water bottle assembly of claim 1, wherein the inner wall comprises copper plated stainless steel, such that copper is positioned on an inner surface of the inner wall in contact with the water in the container.

3. The insulated water bottle assembly of claim 1, wherein the container is substantially cylindrical.

4. The insulated water bottle assembly of claim 3, wherein the container is tapered adjacent to the open top, such that the open top is circumferentially smaller than a bottom of the container.

5. The insulated water bottle assembly of claim 1, wherein the insulator comprises a gas or foamed elastomer.

6. The insulated water bottle assembly of claim 5, wherein the insulator comprises air, nitrogen, or a noble gas.

7. The insulated water bottle assembly of claim 1, further including a lid selectively engageable to the shell for reversibly closing the open top.

8. The insulated water bottle assembly of claim 7, wherein the lid comprises a cap having external threads complementary to internal threads positioned in the cylindrical threaded section of the shell adjacent to the open top, such that the cap is selectively threadedly engageable to the shell for reversibly closing the open top.

9. An insulated water bottle system comprising:
a shell defining an interior space, the shell being formed to define a container comprising an inner wall, an outer wall, and an open top, the inner wall comprising copper, the outer wall comprising stainless steel, the shell including a cylindrical threaded section extending vertically between a top edge of the outer wall and a top edge of the inner wall, a space between the outer wall and the inner wall being constant from the top edge of the wall downward within the shell;
water positioned in the container, such that a user is positioned for dispensing the water from the open top, wherein the inner wall is configured for inhibiting growth of microbes and for contributing copper ions to the water positioned in the container; and
an insulator positioned in the interior space, wherein the insulator is configured for limiting heat transfer from the water to the ambient environment.

10. The insulated water bottle system of claim 9, wherein the inner wall comprises copper plated stainless steel, such that copper is positioned on an inner surface of the inner wall in contact with the water in the container.

11. The insulated water bottle system of claim 9, wherein the container is substantially cylindrical.

12. The insulated water bottle system of claim 11, wherein the container is tapered adjacent to the open top, such that the open top is circumferentially smaller than a bottom of the container.

13. The insulated water bottle system of claim 9, wherein the insulator comprises a gas or foamed elastomer.

14. The insulated water bottle system of claim 13, wherein the insulator comprises air, nitrogen, or a noble gas.

15. The insulated water bottle system of claim 9, further including a lid selectively engageable to the shell for reversibly closing the open top.

16. The insulated water bottle system of claim 15, wherein the lid comprises a cap having external threads complementary to internal threads positioned in the cylindrical threaded section of the shell adjacent to the open top, such that the cap is selectively threadedly engageable to the shell for reversibly closing the open top.

17. An insulated water bottle assembly comprising:
a shell defining an interior space, the shell being formed to define a container comprising an inner wall, an outer wall, and an open top, the inner wall comprising copper, the outer wall comprising stainless steel, wherein the container is configured for positioning of water, such that a user is positioned for dispensing the water from the open top, wherein the inner wall is configured for inhibiting growth of microbes and for contributing copper ions to the water positioned in the container, the inner wall comprising copper plated stainless steel, such that copper is positioned on an inner surface of the inner wall in contact with the water in the container, the container being substantially cylindrical, the container being tapered adjacent to the open top, such that the open top is circumferentially smaller than a bottom of the container, the shell including a cylindrical threaded section extending vertically between a top edge of the outer wall and a top edge of the inner wall, a space between the outer wall and the inner wall being constant from the top edge of the wall downward within the shell;
an insulator positioned in the interior space, wherein the insulator is configured for limiting heat transfer from the water in the container to the ambient environment, the insulator comprising a gas or foamed elastomer, the insulator comprising air, nitrogen, or a noble gas; and
a lid selectively engageable to the shell for reversibly closing the open top, the lid comprising a cap having external threads complementary to internal threads positioned in cylindrical threaded section of the shell adjacent to the open top, such that the cap is selectively threadedly engageable to the shell for reversibly closing the open top.
